(19) United States
(12) Patent Application Publication
(10) Pub. No.: US 2005/0028085 A1
(43) Pub. Date: Feb. 3, 2005

(54) Dynamic generation of voice application information from a web server

(76) Inventors: James S. Irwin, Stevens, PA (US); Alan J. Vleiman, Elverson, PA (US); Karl Wilmer Scholz, Strafford, PA (US)

Correspondence Address: Lise A Rode;Unisys Corporation, Unisys Way, MS E 8 114, Blue Bell, PA, 19424, US

(21) Appl. No.: 10/476,746

(22) PCT Filed: May 3, 2002
(86) PCT No.: PCT/US02/13982

(30) Foreign Application Priority Data
May 4, 2001 (US) 60288708

(51) Int. Cl. G06F 17/00

(52) U.S. Cl. 715/513

(57) ABSTRACT

A server (410) communicates with a client (435) in a client-server architecture to carry out a dialogue with a user. The client comprises a browser (440) that supports a particular mark-up language, such as voiceXML. The server comprises a dialogue flow interpreter (DFI) (420) that reads a data file containing information representing different states of the dialogue with the user and that uses that information to generate for a given state of the dialogue objects (310) representing prompts to be played to the user, grammars of expected responses from the user, and other state information.

### CROSS-REFERENCE TO RELATED APPLICATIONS

This application claims the benefit of the filing date of U.S. Provisional Application Ser. No. 60/288,708, entitled “Dynamic Generation of Voice Application Information from a Web Server,” filed May 4, 2001, which application is incorporated herein by reference in its entirety.

The subject matter disclosed herein is related to the subject matter disclosed in U.S. Pat. No. 5,995,918, entitled “System And Method For Creating A Language Grammar Using A Spreadsheet Or Table Interface,”(issued Nov. 30, 1999), U.S. Pat. No. 6,094,635, entitled “System and Method for Speech Enabled Application,” (issued Jul. 25, 2000), U.S. Pat. No. 6,321,198, entitled “Apparatus for Design and Simulation of Dialogue,” (issued Nov. 20, 2001), and pending U.S. patent application Ser. No. 09/702,244, entitled “Dialogue Flow Interpreter Development Tool,” filed Oct. 30, 2000, all of which are assigned to the assignee of the instant application, and the contents of which are hereby incorporated by reference in their entireties.

### FIELD OF THE INVENTION

The present invention relates to the field of speech-enabled interactive voice response (IVR) systems and similar systems involving a dialog between a human and a computer. More particularly, the present invention is related to a system and method of dynamically generating voice application information from a server, and particularly dynamic generation of mark-up language documents to a browser capable of rendering such mark-up language documents on a client computer.

### BACKGROUND OF THE INVENTION

The explosive growth of the Internet, and particularly the World Wide Web, over the last several years cannot be understated. The corresponding impact on the global economy has been similarly dramatic. Virtually any type of information is available to a user who is even only remotely familiar with navigating this network of computers. Yet, there are still instances where information that may be important or even critical to an individual, though otherwise available on the Web, is without his or her reach. For example, an individual who is traveling might desire to obtain information regarding flight departures for a particular airline carrier from his current destination using a landline phone, mobile phone, wireless personal digital assistant, or similar device. While that information might be readily available from the Web server of the airline carrier, in the past, the traveler did not have access to the Web server from a phone. Recently, however, advances have been made to marry telephones and telephony-based voice applications with the World Wide Web. One such advance is the Voice Extended Markup Language (VoiceXML).

VoiceXML is a Web-based markup language for representing human/computer dialog. It is similar to Hypertext Markup Language (HTML), but assumes a voice browser having both audio input and output. As seen in FIG. 1, a typical configuration for a VoiceXML system might include a web browser 160 (residing on a client) connected via the Internet to a Web server 110, and a VoiceXML gateway node 140 (including a voice browser) that is connected to both the Internet and the public switched telephone network (PSTN). The web server can provide multimedia files and HTML documents (including scripts and similar programs) when requested by web browser 160, and can provide audio/grammar information and VoiceXML documents (including scripts and similar programs), at the request of the voice browser 140.

As interest in deployment of speech applications written in VoiceXML expands, the need for a sophisticated and elegant integration of the voice user interface front end and business-rule driven back end becomes ever more important. VoiceXML itself is a satisfactory vehicle for expressing the voice user interface, but it does little to assist in implementing the business rules of the application.

Within the Internet community, the problem of integrating the user interface (HTML browser) and business rule-driven back end has been addressed through the use of dynamically generated HTML, where server code is written that defines both the application and its back-end data manipulation. When the user fetches an application via a browser, the application dynamically generates HTML (or XML) that the web server conveys as an http response. The user's input (mouse clicks, and keyboard entries) are collected by the browser and returned in an HTTP request (GET or POST) to the server where it is processed by the application.

This dynamic generation model has been extended by the VoiceXML community for use in speech applications. Server-resident application code interacts with data visible to the server and produces a stream of VoiceXML. But this approach requires the development of custom code for each new application, or (at best) reusable components of the custom code that can be structured as templates that facilitate their reuse.

Accordingly, there is a need for a speech application development and deployment architecture that leverages the best of the dynamic generation architecture described above, yet exploits the extreme simplification of application development provided by an integrated service creation environment, such as the family of application development tools that comprise the Natural Language Speech Assistant (NLSA) developed by Unisys corporation. The present invention satisfies this need.

### SUMMARY OF THE INVENTION

The present invention enables an application developer to design a speech-enabled application using existing speech application development tools in an integrated service creation environment, and then to deploy that speech application in a client-server environment in which the speech application dialogue with the user is carried out through the dynamic generation of documents in a particular mark-up language and the rendering of those documents by a suitable client browser. One embodiment of the invention comprises a server that communicates with a client in a client-server environment to carry out a dialogue with a user, wherein the client comprises a browser that fetches from the server a document containing instructions in a mark-up language and renders the document in accordance with the mark-up language instructions to provide interaction with the user. The server comprises a dialogue flow interpreter (DFI) that reads a data file containing information representing different states of the dialogue with the user and that uses that information to generate for a given state of the dialogue objects representing prompts to be played to the user, grammars of expected responses from the user, and other state information. The data file is generated by a speech application developer using an integrated service creation environment, such as the Unisys NLSA. The server further comprises a mark-up language generator that generates, within a document, instructions in the mark-up language of the client browser that represent an equivalent of the objects generated by the DFI. In essence, the mark-up language generator serves as a wrapper around the DFI to transform the information normally generated by the DFI for use with monolithic speech applications into dynamically generated mark-up language documents for use in a browser-based client-server environment. A server application instantiates the DFI and mark-up language generator to provide the overall shell of the speech application and to supply necessary business logic behind the application. The server application is responsible for delivering generated mark-up language documents to the client browser and for receiving requests and associated information from the browser. An application server (i.e., application hosting software) may be used to direct communications between one or more browsers and one or more different speech applications deployed in this manner. The speech application development and deployment architecture of the present invention can be used to enable dynamic generation of speech application information in any of a variety of mark-up languages, including voiceXML, Speech Application Language Tags (SALT), hypertext markup language (HTML), and others. The server can be implemented in a variety of application service provider models, including the Java Server Pages (JSP)/Servlet model developed by Sun Microsystems, Inc. (as defined in the Java Servlet API specification), and the Active Server Pages (ASP)/Internet Information Server (IIS) model developed by Microsoft Corporation.

Other features of the present invention will become evident hereinafter.

### BRIEF DESCRIPTION OF THE FIGURES

The foregoing summary, as well as the following detailed description, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram illustrating an exemplary prior art environment employing a voice-enabled browser in a client-server environment;

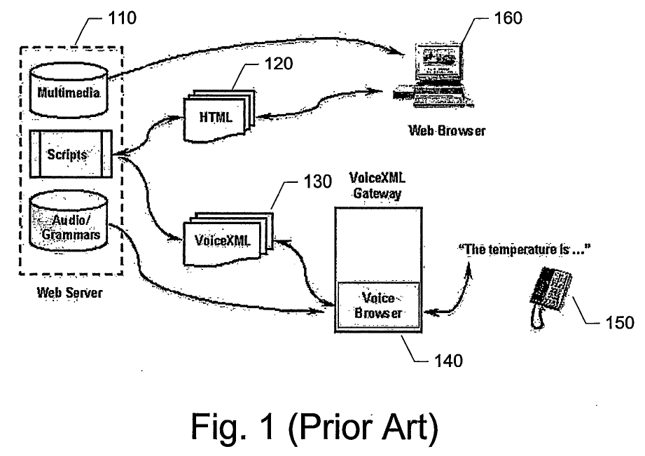

FIG. 2 is a block diagram illustrating a development and deployment environment for a monolithic speech application;

FIG. 3 is a diagram illustrating further details of a dialogue flow interpreter of the environment illustrated in FIG. 2;

FIG. 4 is a block diagram of a server for use in a client-server environment to provide a dialogue with a user in accordance with one embodiment of the present invention; and

FIG. 5 is an example of a data file employed by the dialogue flow interpreter of FIGS. 2 and 3 to direct the dialogue of a speech application.

### DETAILED DESCRIPTION OF THE INVENTION

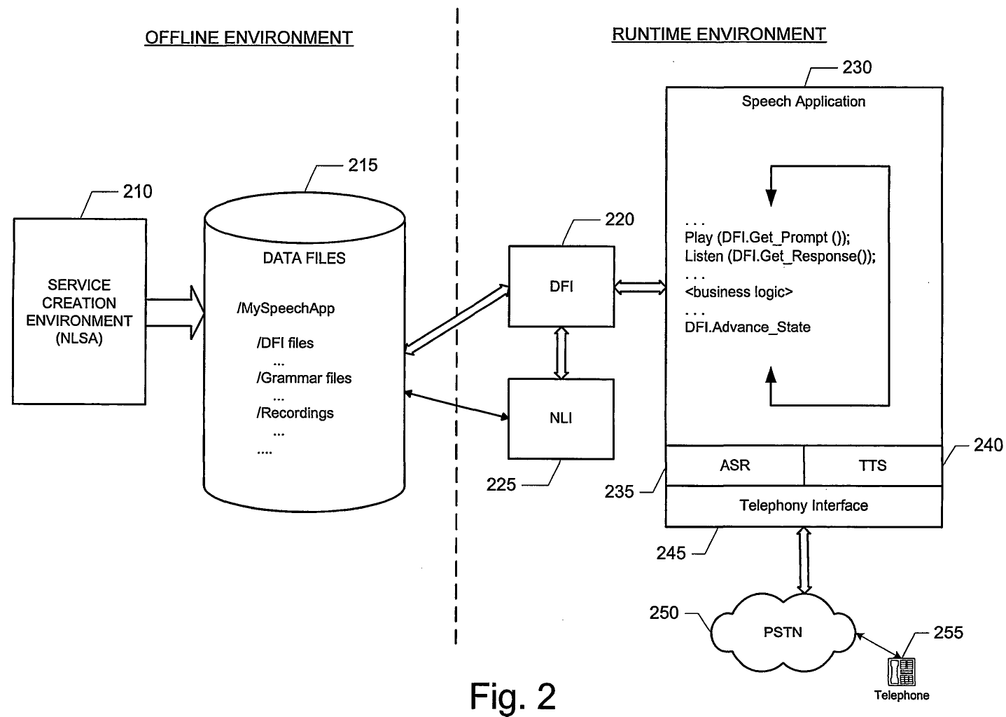

FIG. 2 illustrates an exemplary architecture for the design and deployment of monolithic speech applications. The Unisys NLSA family of speech application development tools is one example of this approach to speech application development and deployment. As described in greater detail hereinafter, the present invention builds upon this approach to speech application development to enable speech applications developed in this manner to be deployed in a client-server environment in which the speech application dialogue with the user is carried out through the dynamic generation of documents in a particular mark-up language and the rendering of those documents by a suitable client browser. From the perspective of the speech application developer, however, the development process is essentially no different. While the Unisys NLSA is one example of a speech application design and development environment that implements the architecture shown in FIG. 2, and therefore serves as the basis of the exemplary description provided below, it is understood that the present invention is by no means limited to implementation in the context of the Unisys NLSA environment. Rather the present invention may be employed in the context of any speech application design and development environment that implements this architecture or an equivalent thereof.

As shown, the architecture consists of both an offline environment and a runtime environment. The principal offline component is an integrated service creation environment. In this example, the integrated service creation environment comprises the Natural Language Speech Assistant or “NLSA” (developed by Unisys Corporation, Blue Bell, Pa.). Integrated service creation environments, like the Unisys NLSA, enable a developer to generate a series of data files 215 that define the dialogue flow (sometimes referred to as the “call flow”) of a speech application as well as the prompts to be played, expected user responses, and actions to be taken at each state of the dialogue flow. These data files 215 can be thought of as defining a directed graph where each node represents a state of the dialogue flow and each edge represents a response-contingent transition from one dialog state to another. The data files 215 output from the service creation environment can consists of sound files, grammar files (to constrain the expected user responses received from a speech recognizer), and files that define the dialogue flow (e.g., DFI files) in a form used by a dialogue flow interpreter (DFI) 220, as described more fully below. In the case of the NLSA, the files that define the dialogue flow contain an XML representation of the dialogue flow.

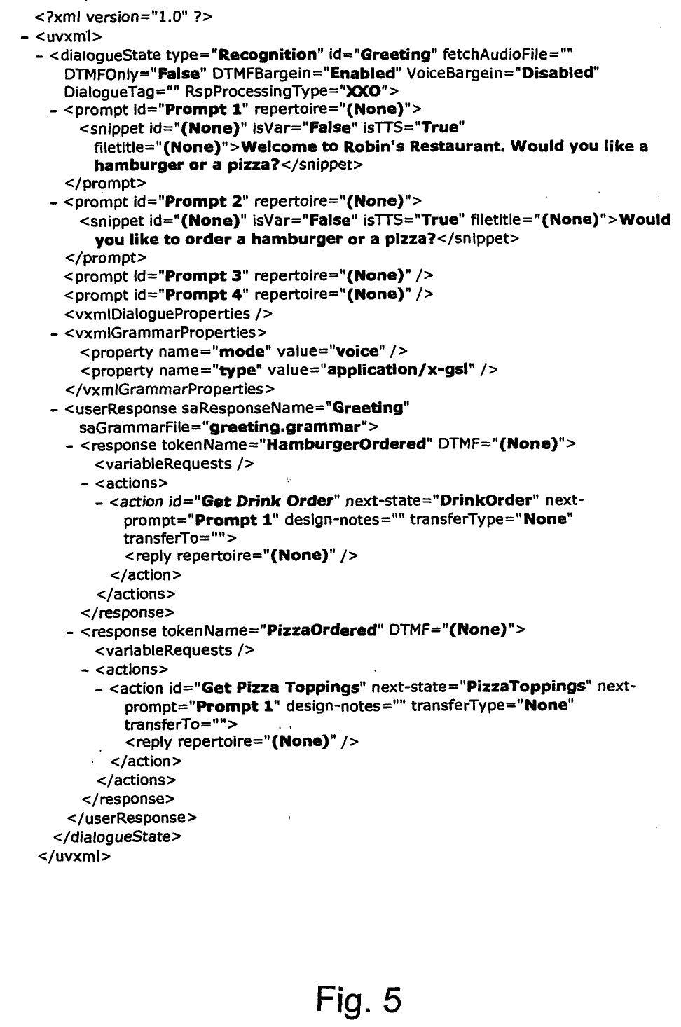

FIG. 5 is an exemplary DFI file containing an XML representation of a first state of a dialogue flow for an exemplary speech application that allows users who access the application via a telephone to order a food item, such as a hamburger or a pizza, from a vendor called “Robin's Restaurant.” As shown, the first state in this exemplary application is called “Greeting,” and the XML file for this state specifies the prompt to be played to the user (e.g., “Welcome to Robin's Restaurant. Would you like a hamburger or a pizza?”), a grammar file (e.g., “greeting.grammar”) that defines a grammar for use in conjunction with an automatic speech recognizer (ASR) to enable the application to understand the spoken response of a user, and the actions to be taken based on the user response (e.g., next-state “DrinkOrder” if user chooses hamburger, or next-state=“Get Pizza Toppings” if user orders pizza).

Referring again to FIG. 2, in addition to generating the data files that the dialogue flow interpreter uses to control the flow of a speech application 230, the service creation environment will also generate shell code for the speech application 230—the basic code necessary to run the speech application. The developer may then add additional code to the speech application 230 to implement the business logic behind the application, such as code that interacts with a database to store and retrieve information relevant to the particular application. For example, this business logic code may maintain an inventory for a vendor or maintain a database of information that a user may desire to access. Thus, the integrated service creation environment generates the code necessary to implement the voice dialogue with the user, and the developer completes the application by adding the code to implement the business-rule driven back end of the application.

The Unisys NLSA uses an easy-to-understand spread sheet metaphor to express the relationships between words and phrases that define precisely what the end user is expected to say at a given state in a dialogue. The tool provides facilities for managing variables and sound files as well as a mechanism for simulating the application prior to the generation of actual code. The tool also produces recording scripts (for managing the recording of the ‘voice’ of the application) and dialog design documents summarizing the application's architecture. Further details regarding the NLSA, and the creation of the data files 215 by that tool, are provided in U.S. Pat. Nos. 5,995,918 and 6,321,198, and in co-pending, commonly assigned application Ser. No. 09/702,244.

The runtime environment of the speech application development and deployment architecture of FIG. 2 comprises the speech application shell and business logic code 230 and one or more instances of a dialogue flow interpreter 220 that the speech application 230 instantiates and invokes to control the application dialogue with a user. The speech application 230 may interface with an automatic speech recognizer (ASR) 235 to convert spoken utterances received from a user into a textual form useable by a speech application. The speech application 230 may also interface with a text-to-speech engine (TTS) 240 that converts textual information to speech to be played to a user. The speech application 230 may alternatively play pre-recorded sound files to the user in lieu of, or in addition to, use of the TTS engine 240. The speech application 230 may also interface to the public switched telephone network (PSTN) via a telephony interface 245 to provide a means for a user to interact with the speech application 230 from a telephone 255 on that network. In other embodiments, the speech application could interact with a user directly from a computer, in which case the user speaks and listens to the application using the microphone and speakers of the computer system. Still another possibility is for the user to interact with the application via a voice-over-IP (VOIP) connection.

In the Unisys NLSA environment, the runtime environment may also include a natural language interpreter (NLI) 225, in the event that its functionality is not provided as part of the ASR 235. The NLI accesses a given grammar file of the data files 215, which expresses valid utterances and associates them with tokens and provides other information relevant to the application. The NLI extracts and processes a user utterance based on the grammar to provide information useful to the application, such as a token representing the meaning of the utterance. This token may then, for example, be used to determine what action the speech application will take in response. The operation of an exemplary NLI is described in U.S. Pat. No. 6,094,635 (in which it is referred to as the “runtime interpreter”) and in U.S. Pat. No. 6,321,198 (in which it is referred to as the “Runtime NLI”).

The dialog flow interpreter (DFI) is instantiated by the speech application 230. The DFI accesses the representation of the application contained in the data files 215 produced by the service creation environment. The DFI furnishes the critical components of a speech application dialog state, in the form of objects, to the invoking program by consulting the representation of the speech application in the data files 215. In order to understand this process, it is essential to understand the components that make up a dialog state.

Essentially, each state of a dialogue represents one conversational interchange between the application and a user. Components of a state are defined in the following table:

| Component | Function | Examples |
|---|---|---|
| Prompt | Defines what the computer says to the | Would you like to place an order? |
| | end user | |
| Response | Defines every possible user | YES (yes, yes please, certainly . . . ) |
| | response to the prompt, including | NO (No, not right now, no thanks . . . ) |
| | its implications to the application | HELP (Help, How do I do that . . . ) |
| | (i.e. meaning, content) | OPERATOR (I need to talk to a |
| | | person) |
| | | . . . |
| Action | Defines the action to be | YES/System Available - go to |
| | performed for each response | PLACEORDER state |
| | based on current conditions | YES/System Unavailable - go to |
| | | CALLBACKLATER state |
| | | . . . |

In the Unisys NLSA, a tool within the service creation environment is used to refine each response down to the actual words and phrases that the end user is expected to say. Variables can be introduced in place of constant string literals in prompts and responses, and variables as well as actions can be explicitly associated with data storage activities. The complete specification of a speech application, then, requires the specification of all the application's dialog states, and the specification of each of these internal components for each state.

When invoked by the speech application 230 at runtime, the DFI provides the current dialog state as well as each of the components or objects required to operate that state, such as:

| Component | Function |
|---|---|
| Prompt | Instantiates all variables then returns the complete prompt |
| | as either a list of wave files or text suitable for rendering |
| | by TTS |
| Response | Returns a complete specification needed to convert user's |
| | utterance into meaning for the application. |
| Action | Defines the action to be taken by the application in |
| | response to input from the user and non-user interface |
| | contingencies. An action is selected by the application and |
| | determines the next state to be set up by the DFI |

The source of the information provided by the DFI is drawn from the representation of the application produced by the service creation environment in the data files 215.

In this manner, the DFI and associated data files 215 contain the code and information necessary to implement most of the speech application dialogue. In its simplest form, therefore, the speech application 230 need only implement a loop, such as that illustrated in FIG. 2, where the application simply calls methods on the DFI 220, for example, to obtain information about the prompt to be played (e.g., “DFI.Get_Prompt( )), to obtain information about the expected response of a user and its associated grammar (e.g., “DFI.Get_Response( )), and after performing any necessary business logic behind a given state, causing the dialogue to advance to the next state (e.g., “DFI.Advance_State”).

In the Unisys embodiment of a DFI, the speech application 230, which can be coded by the developer in any of a variety of programming languages, such as C, Visual Basic, Java, or any other programming language, instantiates the DFI 220 and invokes it to interpret the design specified in the data files 215. The DFI 220 controls the dialogue flow through the application, supplying all the underlying code that previously the developer would have had to write. The DFI 220 in effect provides a library of “standardized” objects that implement the low-level details of a dialogue. The DFI 220 is implemented as an application programming interface (API) to further simplify the implementation of the speech application 230. The DFI 215 drives the entire dialogue of the speech application 230 from start to finish automatically, thus eliminating the crucial and often complex task of dialogue management. Traditionally, such a process is application dependent and therefore requires re-implementation for each new application.

As mentioned above, a dialogue of a speech application includes a series of transitions between states. Each state has its own set of properties that include the prompt to be played, the speech recognizer's grammar to be loaded (to listen for what the user of the voice system might say), the reply to a caller's response, and actions to take based on each response. The DFI 220 keeps track of the state of the dialogue at any given time throughout the life of the application, and exposes functions to access state properties.

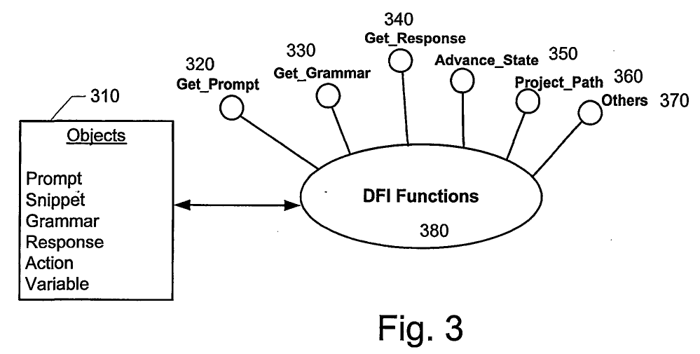

Referring to FIG. 3, in the Unisys NLSA, the properties (prompts, responses, actions, etc.) of a state to which the DFI provides access are embodied in the form of objects 310. Examples of these objects include but are not limited to, a Prompt object, a Snippet object, a Grammar object, a Response object, an Action object, and a Variable object. Exemplary DFI functions 380 return some of the objects described above. These functions include:

Get_Prompt( ) 320: returns a prompt object containing information defining the appropriate prompt to play; this information may then be passed, for example, to the TTS engine 450, which may convert it to audio data to be played to a user,

Get_Grammar( ) 330: returns a grammar object containing information concerning the appropriate grammar for the current state; this grammar is then loaded into the speech recognition engine (ASR) 445 to constrain the recognition of a valid utterance from a user;

Get_Response( ) 340: returns a response object comprised of the actual user response, any variables that this response may contain, and all possible actions defined for this response; and

Advance_State 350: transitions the dialogue to the next state.

Other DFI functions 370 are used to retrieve state-independent properties (i.e., global properties). These include but are not limited to information concerning the directory paths for the various data files 215 associated with the speech application, the application's input mode (e.g., DTMF or Voice), the current state of the dialogue, and the previous state of the dialogue. All of these functions can be called from the speech application 230 code to provide information about the dialogue during the execution of the speech application.

Further details as to the function and operation of the DFI 220 may be found in co-pending, commonly assigned U.S. patent application Ser. No. 09/702,244, entitled “Dialogue Flow Interpreter Development Tool,” filed Oct. 30, 2000.

As described above and illustrated in FIGS. 2 and 3, the integrated service creation environment 210, the data files 215, and the runtime components of the DFI 220 and NLI 225 have heretofore been used in the creation of monolithic speech applications 230. The present invention builds upon the architecture illustrated in FIGS. 2 and 3 to enable speech applications developed in this manner to be deployed in a client-server environment in which the speech application dialogue with the user is carried out through the dynamic generation of documents in a particular mark-up language and the rendering of those documents by a suitable client browser.

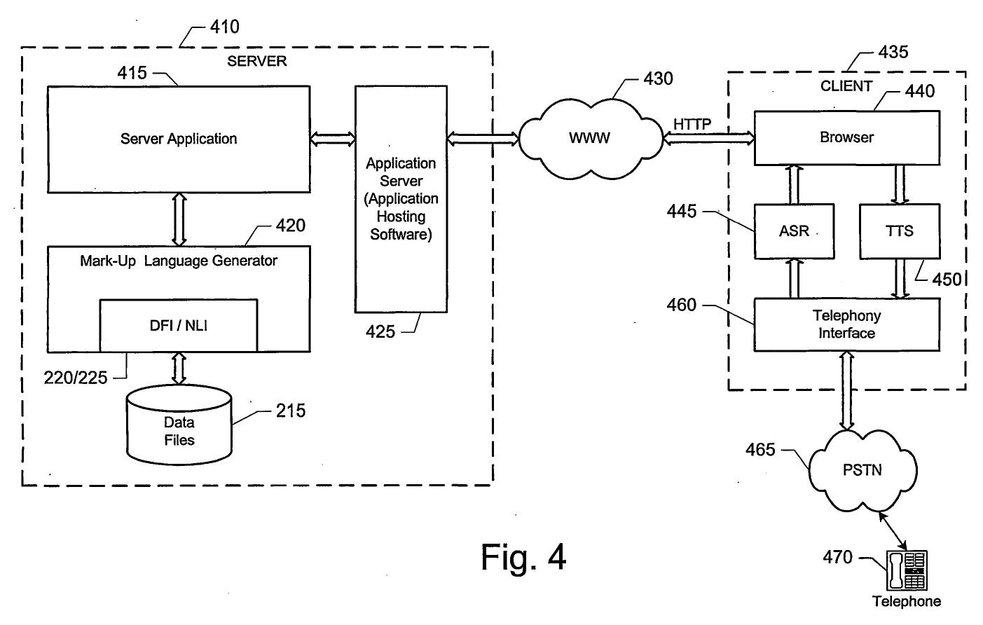

The new architecture for speech application development and deployment of the present invention is illustrated in FIG. 4. FIG. 4 illustrates the architecture of the runtime components of the present invention. The offline components are essentially the same as for the architecture illustrated in FIG. 2. That is, an integrated service creation environment is employed to generate a set of data files 215 defining the dialogue flow of a speech application. As in the architecture of FIG. 2, the new architecture of the present invention relies upon the same dialogue flow interpreter (DFI) 220 (and optionally the NLSA embodiment of the natural language interpreter (NLI) 225) to manage and control the dialogue with a user. The architecture of the present invention, however, is designed to enable a speech application that implements that dialogue to be deployed in a client-server environment in which the speech application dialogue with the user is carried out through the dynamic generation of documents in a particular mark-up language and the rendering of those documents by a suitable client browser. This client-server environment is illustrated in FIG. 4.

As shown, the client 435 comprises a browser 440 that fetches from the server a document containing instructions in a mark-up language and renders the document in accordance with the mark-up language instructions to provide interaction with the user. The present invention can be used to enable dynamic generation of speech application information in any of a variety of mark-up languages, including voiceXML, Speech Application Language Tags (SALT), hypertext markup language (HTML), and others such as Wireless Markup Language (WML) for Wireless Application Protocol (WAP)-based cell phone applications, and the W3 platform for handheld devices. Hence, the browser may comprise a voiceXML-compliant browser, a SALT-compliant browser, an HTML-compliant browser, a WML-compliant browser or any other markup language-compliant browser. Examples of voiceXML-compliant browsers include “SpeechWeb” commercially available from PipeBeach AB, “Voice Genie” commercially available from Voice Genie Technology Inc., and “Voyager” commercially available from Nuance Communications. VoiceXML browser products generally include an automatic speech recognizer 445, a text-to-speech synthesizer 450, and a telephony interface 460. The ASR 445, TTS 450, and telephony interface may also be supplied by different vendors.

As illustrated in FIG. 4, in the case of a voiceXML-enabled browser, a user may interact with the browser from a telephone or other device connected to the public switched telephone network 465. Alternatively, the user may interact with the browser using a Voice-Over IP connection (VOIP) (not shown). In other voice embodiments, the client may be executing on a workstation or other computer to which a user has direct access, in which case the user may interact with the browser 440 using the input/output capabilities of the workstation (e.g., mouse, microphone, speakers, etc.). In the case of non-voice browsers, such as an HTML browser or a WML browser, the user interacts with the browser graphically, for example.

The browser 440 communicates with a server 410 of the present invention through standard Web-based HTTP commands (e.g., GET and POST) transmitted over, for example, the Internet 430. However, the present invention can be deployed over any private or public network, including local area networks, wide-area networks, and wireless networks, whether part of the Internet or not.

Preferably, an application server 425 (i.e., application hosting software) intercepts requests from the client browser 440 and forwards those requests to the appropriate speech application (e.g., server application 415) hosted on the server computer 410. In this manner, multiple speech applications may be available for use by a user.

In addition to the dialogue flow interpreter (DFI) 220 (and optionally the NLI 225) and the data files 215 discussed above, the server 410 further comprises a mark-up language generator 420 that generates, within a document, instructions in the mark-up language supported by the client browser 440 that represent equivalents of the objects generated by the DFI. That is, the mark-up language generator 420 serves as a wrapper around the DFI 220 (and optionally the NLI 225) to transform the information normally generated by the DFI for use with monolithic speech applications, such as the prompt, response, action and other objects discussed above, into dynamically generated mark-up language instructions within a document that can then be served to the client browser 440.

By way of example only, a prompt object returned by the DFI 220 based on the XML representation of the exemplary DFI file illustrated in FIG. 5 may contain the following information:

<prompt id = “Prompt 1” repertoire = “(None)”>

<snippet id = “(None)” isVar = “False” isTTS = “True” filetitle =
“(None)”
Would you like to order a hamburger or a pizza?</snippet>

</prompt>

The prompt object is essentially a representation in memory of this information. In this example, the mark-up language generator 420 may generate the following VoiceXML instructions for rendering by a VoiceXML-enabled client browser:

<block>

<prompt>Welcome to Robin's Restaurant. Would you like a

hamburger or a pizza?</prompt>

</block>

These instructions would be generated into a document to be transmitted back to the client browser. The following is an example of a larger document containing a voiceXML representation of several objects associated with a state of the exemplary dialogue of FIG. 5:

<?xml version=“1.0” encoding=“ISO-8859-1” ?>
<vxml version=“2.0” xml:lang=“en-US”

```
  application=“http://localhost:8080/LabFastFood/voiceapp?FetchingRootPage=
  true”>
<meta name=“author” content=“Generated by NLSA 5.01.0023” />
<form>
```

<block>

<prompt>Welcome to Robin's Restaurant. Would you like a

hamburger or a pizza?</prompt>

</block>
<var name=“token” expr=“” />
<field name=“userinput”>

<grammar version=“1.0” type=“application/x-gsl” xml:lang=“en-
US” mode=“voice”>

<![CDATA[
.Greetinggreeting ((( ?(i would like) ) a) [(hamburger {
<token “HamburgerOrdered”> return($string) }) (pizza {
<token “PizzaOrdered”> return($string) })])

```
  ]]>
</grammar>
  <filled>
```

<assign name=“token”

expr=“application.lastresult$.interpretation” />

<submit next=“http://localhost:8080/LabFastFood/voiceapp”

namelist=“token userinput$.utterance
userinput$.confidence” />

</filled>

</field>

</form>

</vxml>

A server application 415, similar to the speech application 230 illustrated in FIG. 2 but designed for deployment in the client-server environment of FIG. 4, instantiates the DFI 220 and mark-up language generator 420 to provide the overall shell of the speech application and to supply necessary business logic behind the application. The server application 415 is responsible for delivering generated mark-up language documents to the client browser 440 and for receiving requests and associated information from the browser 440, via, for example, the application server 425. The server application 415 and application server 425 can be implemented in a variety of application service provider models, including the Java Server Pages (JSP)/Servlet model developed by Sun Microsystems, Inc. (as defined in the Java Servlet API specification) (in which case the server application 415 conforms to the Java Servlet specification of that model and the application server 425 may comprise the “Tomcat” reference implementation provided by “The Jakarta Project,” for example), and the Active Server Pages (ASP)/Internet Information Server (IIS) model developed by Microsoft Corporation (in which the application server 425 comprises Microsoft IIS).

In one embodiment, the server application 415 may be embodied as an executable script on the server 410 that, in combination with appropriate .asp or .jsp files and the instances of the DFI 220 and mark-up language generator 420, produces the mark-up language document to be returned to the browser 440.

Preferably, the service creation environment will in addition to producing the data files 215 that define the dialogue of the speech application, also produce the basic shell code of the server application 415 to further relieve the application developer from having to code to a specific client-server specification (e.g., JSP/Servlet or ASP/IIS). All the developer will need to do is to provide the necessary code to implement the business logic of the application. Although other web developers use ASP/IIS and JSP/Servlet techniques on servers to dynamically generate markup language code, the architecture of the present invention is believed to be the first to use an interpretive engine (ie., the DFI 220) on the server to retrieve essential information representing the application that was itself built by an offline tool.

The DFI 220 is ideally suited to provide the information source from which a mark-up language document can be dynamically produced. Using either an ASP/IIS or ISP/Servlet model, the server application 415 invokes the same DFI methods described above, but the returned objects are then translated by the markup language generator 420 into appropriate mark-up language tags and packaged in a mark-up language document, permitting the server application 415 to stream the dynamically generated mark-up language documents to a remote client browser. Whenever the Action at a given dialogue state includes some database read or write activity, that activity is performed under control of the DFI 220 and the result of the transaction is reflected in the generated mark-up language instructions.

Thus, the DFI 220 effectively becomes an extension of the server application 415. In the present embodiment, the speech application dialogue and its associated speech recognition grammars, audio files, or application-specific data that make up the data files 215 reside on server-visible data stores. The files representing the dialogue flow are represented in XML (e.g., FIG. 5) and the grammars are represented in the Speech Recognition Grammar Specification for the W3C Speech Interface Framework (or, if necessary, in a vendor-specific grammar format). In principle, therefore, a single service creation environment can be used to build a speech application in its entirety, while permitting developers to create and deploy speech applications with minimal attention to the technical intricacies of particular mark-up languages or client-server environments.

In operation, the control of a dialogue with a user in accordance with the architecture of the present invention generally occurs as follows:
1. A user calls into the client browser 440 and selects a particular speech application by virtue of having dialed a particular phone number or provided a unique user identification that maps to that speech application.
2. The browser 440 requests the selected application 415 from the server computer 410 (via, for example, the application server 425) by fetching a document from the server.
3. The server application 415 calls the appropriate methods on the DFI 220 to obtain the objects associated with the current state of the dialogue (e.g., prompt, response, action, etc.). The mark-up language generator 420 generates the equivalent mark-up language instructions for the objects to be returned into an appropriate mark-up language document (e.g., instructions to cause the browser 440 to play a prompt and listen for a specified user utterance).
4. The user utterance and the meaning of the utterance expressed as variables (as determined by the ASR) are passed back to the server application 415 by the browser 440 (e.g., via an HTTP “POST”).
5. The server application 415 uses the variables associated with the utterance to execute the business rules of the speech application and to transition to the next state via the appropriate call to the DFI 220 (e.g., Advance_State( ) 350). The next state may contain info such as what prompt to play and what to listen for, and this information is again passed back to the browser in the form of a mark-up language document. The process then essentially repeats.

In embodiments in which the ASR is not equipped to extract the meaning from an utterance, then in step 4, the utterance may be passed back to the server application 415, which may then invoke an NLI (e.g., NLI 225) to extract the meaning.

In the above manner, state after state is executed until the application has performed the desired task.

Thus, it will be appreciated that the above architecture allows the use of the DFI 220 on the server 410 to retrieve essential information from the data files 215 representing the speech application dialogue (as created by the offline service creation environment). While most solutions involve committing to a particular technology, thus requiring a complete rewrite of an application if the “hosting technology” is changed, the design abstraction approach of the present invention minimizes the commitment to any particular platform. Under the system of the present invention a user does not need to learn a particular mark-up language, nor the intricacies of a particular client-server model (e.g., ASP/IIS or JSP/Servlet).

Benefits of the above architecture include ease of movement between competing Internet technology “standards” such as JSP/Servlet and ASP/IIS. A further benefit is that it protects the user and application designer from changes in an evolving markup language standard (e.g., VoiceXML). Finally, the novel architecture disclosed herein provides for multiple delivery platforms (e.g. VoiceXML for spoken language), WML for WAP-based cell phone applications, and the W3 platform for handheld devices.

The architecture of the present invention may be implemented in hardware or software, or a combination of both. When implemented in software, the program code executes on programmable computers (e.g., server 410 and client 435) that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices. Such program code is preferably implemented in a high level procedural or object oriented programming language. However, the program code can be implemented in assembly or machine language, if desired. In any case, the language may be a compiled or interpreted language. The program code may be stored on a computer-readable medium, such as a magnetic, electrical, or optical storage medium, including without limitation a floppy diskette, CD-ROM, CD-RW, DVD-ROM, DVD-RAM, magnetic tape, flash memory, hard disk drive, or any other machine-readable storage medium, wherein, when the program code is loaded into and executed by a machine, such as a computer, the machine becomes an apparatus for practicing the invention. The program code may also be transmitted over some transmission medium, such as over electrical wiring or cabling, through fiber optics, over a network, including the Internet or an intranet, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

In the foregoing description, it can be seen that the present invention comprises a new and useful architecture for the development and deployment of speech applications that enables an application developer to design a speech-enabled application using existing speech application development tools in an integrated service creation environment, and then to deploy that speech application in a client-server environment in which the speech application dialogue with the user is carried out through the dynamic generation of documents in a particular mark-up language and the rendering of those documents by a suitable client browser. It should be appreciated that changes could be made to the embodiments described above without departing from the inventive concepts thereof. It should be understood, therefore, that this invention is not limited to the particular embodiments disclosed, but it is intended to cover all modifications within the spirit and scope of the present invention as defined by the appended claims.

1. A server that communicates with a client in a client-server computing system to carry out a dialogue between a user and the computing system, wherein the client comprises a browser that fetches from the server a document containing instructions in a mark-up language and renders the document in accordance with the mark-up language instructions to provide interaction with the user, the server comprising:
a dialogue flow interpreter (DFI) that reads a data file containing information representing different states of said dialogue and that uses that information to generate for a given state of said dialogue an object representing at least one of a prompt to be played to the user and a grammar of expected responses from the user;
a mark-up language generator that generates within a document instructions in said mark-up language that represent an equivalent of the object generated by said DFI; and
a server application that delivers documents containing instructions generated by said mark-up language generator to the client browser.

2. The server recited in claim 1, wherein said mark-up language comprises one of VoiceXML, SALT, HTML, and WML.

3. The server recited in claim 1, wherein said mark-up language comprises voiceXML and wherein said browser comprises a voiceXML-enabled browser.

4. The server recited in claim 1, further comprising an application server that directs communications from the client to said server application of said server.

5. The server recited in claim 4, wherein said application server and server application conform to the JSP/Servlet model.

6. The server recited in claim 4, wherein said application server and server application conform to the ASP/IIS model.

7. A method for carrying out a dialogue between a user and a computer system in a client-server environment, wherein a client comprises a browser that fetches from a server a document containing instructions in a mark-up language and renders the document in accordance with the mark-up language instructions to provide interaction with the user, the method comprising the following performed at the server:
instantiating a dialogue flow interpreter (DFI) at the server in response to a request from a user, the DFI reading a data file containing information representing different states of said dialogue and using that information to generate for a current state of said dialogue an object representing at least one of a prompt to be played to the user and a grammar of expected responses from the user;
generating, within a document, instructions in said mark-up language that represent an equivalent of the object generated by said DFI; and
transmitting the documents containing the generated mark-up language instructions to the client browser.

8. The method recited in claim 7, wherein said mark-up language comprises one of VoiceXML, SALT, HTML, and WML.

9. The method recited in claim 7, wherein said mark-up language comprises voiceXML and wherein said browser comprises a voiceXML-enabled browser.

10. The method recited in claim 7, wherein said transmitting step is performed in accordance with a JSP/Servlet model.

11. The method recited in claim 7, wherein said transmitting step is performed in accordance with an ASP/IIS model.
